(19) United States
(12) Patent Application Publication
(10) Pub. No.: US 2025/0065270 A1
(43) Pub. Date: Feb. 27, 2025

(54) ADVANCED LIQUID DESICCANT SOLUTION REGENERATOR

(71) Applicant: Nortek Air Solutions Canada, Inc., Saskatoon (CA)

(72) Inventors: Philip Paul LePoudre, Saskatoon (CA); Gaoming Ge, Saskatoon (CA)

(21) Appl. No.: 18/720,516

(22) PCT Filed: Dec. 14, 2022
(86) PCT No.: PCT/CA2022/051822

§ 371 Date: Jun. 14, 2024

Related U.S. Application Data
(60) Provisional application No. 63/289,509, filed on Dec. 14, 2021.

(51) Int. Cl. B01D 61/36; B01D 53/00; B01D 53/22

(52) U.S. Cl. CPC B01D 61/3641; B01D 53/002; B01D 53/225; B01D 61/363; B01D 61/366

(57) ABSTRACT

A membrane distillation regenerator can include a first liquid channel through which a first liquid flows at a first temperature, a second liquid channel through which a second liquid flows from the first liquid channel and at a second temperature higher than the first temperature, a condensation cell disposed between the first liquid channel and the second liquid channel, and a permeable membrane disposed between the second liquid channel and the condensation cell. The regenerator can include several distillation stages in which the vapor separated from the second liquid can pass from an evaporation chamber of the second liquid channel through the membrane and into a corresponding condensation chamber of the condensation cell.

### CLAIM OF PRIORITY

This application claims priority to U.S. Provisional Application Ser. No. 63/289,509, filed on Dec. 14, 2021, which is incorporated by reference herein in its entirety, and the benefit of priority of which is claimed herein.

### BACKGROUND

Membrane Distillation (MD) is a process in which vapor molecules are transported through a permeable membrane to be subsequently condensed into liquid water. MD can separate liquid water from dilute solution while concurrently producing a concentrate solution. One common application of MD is for use in desalination of saline water.

In many applications of MD, a hot stream of dilute solution is located on one side of the membrane and a collection area for liquid water condensed from vapor molecules drawn out of the dilute solution is often located on the other side of the membrane. Evaporation occurs from the hot solution side across the membrane and condensation often occurs in the collection area. One driving force that facilitates the transport of the vapor molecules through a membrane layer is thermal diffusion. Generally, the hot solution flows counter to (generally in the opposite direction of) a colder liquid flow running on the opposite side of the membrane. Due to the temperature difference (ΔT) between hot and cold streams, evaporated water molecules diffuse across the membrane from the side with the higher temperature to the side with the lower temperature. In an idealized MD system, the solution temperature changes in both the cold stream and the hot stream would be entirely due to latent heat transfer (or moisture transfer) in the evaporation and condensation processes. However, in practical applications, some portion of the heat flux is lost through sensible heat between the hot and cold channels, and through the condensed water output.

In several approaches, a vapor pressure gradient is additionally implemented between the two sides of the membrane, creating another force causing evaporated liquid from the dilute side to be transported through the membrane to the collection area where the vapor then condenses into the desired liquid, for example, commonly liquid water. Such a gradient can exist where the system is designed to operate with a significant vapor pressure differential across the membrane. The inclusion of a vapor pressure gradient across the membrane can supplement the thermal diffusion to increase the transport of the vapor molecules through the membrane, especially in approaches where thermal diffusion alone is inadequate for acceptable desorption of the vapor. However, applying a vapor pressure gradient can require strong, complex, or expensive membrane materials and decrease the longevity of the membrane due to heavy mechanical loading.

Depending on the design of the condensing/permeate system, MD can be categorized into various types, as described below. For example, in direct contact membrane distillation (DCMD), a cold solution flows opposite a membrane in counter-flow relation to a hot dilute solution, and the water vapor from the hot solution evaporates across the membrane, subsequently producing both condensate water and concentrate solution. In some systems, the hot dilute solution can originate as the cold solution and be heated before being passed against itself on the other side of the membrane. This can conserve heat, since a portion of the sensible heat incidentally transferred from the hot stream to the cold stream can be recovered to preheat the hot stream. Also, this can recover a portion of the heat lost in the condensate water. In such DCMD systems, there is significant sensible heat transfer between the hot and cold streams by conduction, because the hot and cold streams are in direct contact with the membrane. For sufficient thermal diffusion to occur across the membrane, the difference in temperature between the hot and cold streams (ΔT) must be relatively large since only part of the heat supplied to the hot solution is used for the evaporation/condensation process, and the remainder of the heat supplied to the hot solution is lost. This can result in a system with relatively low thermal efficiency.

Air gap membrane distillation (AGMD) can be similar to DCMD except that there is a cavity separating the hot stream/membrane and the cold stream across which the vapor diffuses to a condensation plate which is cooled by the cold stream. Consequently, sensible heat transfer from the hot solution to the cold solution in AGMD is reduced due to the relatively low thermal conductivity of air. This can allow for greater thermal efficiency of the system since the ΔT between the hot and cold streams can be reduced while still maintaining an acceptable rate of thermal diffusion. However, a challenge of AGMD systems is that stagnant air in the cavity can impede the travel of the diffused vapor across the cavity and to the condensation plate, thereby reducing the flux rate of the system to produce condensate water and concentrate distillate.

Sweeping gas membrane distillation (SGMD) utilizes an air stream that flows in the cavity picking up the incoming vapor and becoming humidified as the stream moves along the module. Generally, the temperature of air also increases along the module. The hot humid air is then cooled in an external condenser where liquid water is recovered.

Material gap membrane distillation (MGMD) is a configuration where sand, which has a low thermal conductivity (i.e., acts as a thermal insulator), is used to fill the condensation cavity [see, e.g., L. Francis, et al., “Material gap membrane distillation: A new design for water vapor flux enhancement,” 448 Journal of Membrane Science 240-247 (2013)] between the hot and cold solution streams.

Vacuum membrane distillation (VMD) systems typically utilize a vacuum connected to the cavity to extract the water vapor. Generally, the extracted water vapor is then condensed outside the membrane module in a separate condensation apparatus. VMD systems have also been adapted into multi-stage configurations.

### SUMMARY

The present inventors recognize, among other things, an opportunity for improved membrane distillation (MD) of liquid water from a dilute liquid desiccant solution in a liquid desiccant regenerator (LDR) system in accordance with examples of this application. Also, the present inventors recognize an opportunity for improved performance of conditioning systems incorporating LDR systems in accordance with this disclosure. Example conditioning systems can utilize liquid desiccant for, e.g., cooling or dehumidification resulting from the hygroscopic drying properties of the desiccant. In one example, a conditioning system including an example LDR unit can be employed for air dehumidification in, e.g., residential, commercial, and industrial buildings. In another example, a conditioning system including an example LDR unit includes liquid desiccant which evaporatively cools a cooling liquid or air. The cooled cooling liquid or air is then used to provide cooling to a heat load, e.g., the enclosed space and/or electronic components of a data center.

In such example systems, generally, the liquid desiccant accumulates liquid water as a result of conditioning processes, and therefore requires regeneration to maintain an acceptable desiccant concentration for continued use. The LDR unit can remove a portion of the water from the desiccant such that the LDR unit can output concentrated liquid desiccant and distilled water, and the distilled water can be used as make up water for one or more components of the conditioning system and/or stored. The LDR unit of the present disclosure can provide regeneration of liquid desiccant utilized by one of several components of such a conditioning system to, e.g., help improve thermal performance and/or functionality of the system at or near peak conditions (i.e., hot and/or humid outdoor air conditions).

Example LDR units of the present disclosure can be used with several air conditioning system components using liquid desiccant solutions of various types, including, e.g., Lithium Chloride (LiCl), Magnesium Chloride (MgCl2), Calcium Chloride (CaCl2), Potassium Formate (HCOOK), and mixtures thereof. In an example, the LDR unit includes a cold liquid channel, a hot liquid channel, and a condensation cell disposed between the cold liquid channel and hot liquid channel. As liquid desiccant flows through the hot liquid channel, water vapor evaporates from the liquid desiccant and migrates across a membrane located between the hot liquid channel and the condensation cell. The water vapor then condenses as liquid water within the condensation cell, and concentrated liquid desiccant exits the hot liquid channel, e.g., to be redistributed to a liquid desiccant circuit of the conditioning system. Additionally, liquid water is collected from the condensation cell and can be used as make up water for other components of the conditioning system.

In some examples according to this disclosure, the LDR system can include multiple LDR units. For example, an example LDR system can include a plurality of sets of adjacent liquid panels separated by a condensation cell defining an air or vacuum chamber. The cold liquid channel, the hot liquid channel, and the condensation cell can each be contained within a liquid panel, and the liquid panels can be stacked adjacent one another. Liquid desiccant circulating through the LDR unit flows in parallel through multiple sets of adjacent cold liquid panel, condensation cell, and hot liquid panel. In each such set, liquid desiccant flows through a cold liquid panel, which includes a frame enclosed (to the condensation chamber) by, e.g., an impermeable membrane, film (e.g., aluminum), or plate. The liquid desiccant subsequently flows through a hot liquid panel, which is separated from the cold panel by the condensation cell, and which includes a frame enclosed (to the condensation chamber) by a permeable membrane. The permeable membrane of the hot liquid channel can be structured and configured to be permeable to water vapor, but not to liquid water or other constituents that may be present in the solution. Thus, generally water in a gas phase can pass through the permeable membrane and generally anything in a liquid or solid phase cannot pass through the permeable membrane. As the liquid desiccant flows through the LDR system, water vapor can evaporate from the liquid desiccant, migrate across the permeable membrane, and condense within the condensation cell as liquid water, e.g., on the impermeable membrane, thereby distilling liquid water from the desiccant and generating a relatively concentrated desiccant.

Example LDR units and systems of the present disclosure can include a cascading effect which is made of multiple distillation stages. In this disclosure, multi-stage LDR systems include multiple distillation stages in parallel and in series. Example LDR systems include multiple sets or stages of distillation components that are stacked, e.g., horizontally, to receive and regenerate liquid desiccant in parallel with one another. Each such parallel set or stage also includes multiple distillation stages that are arranged in series. For example, each parallel set or stage can include a cold liquid channel and a hot liquid channel separated by a condensation cell, and multiple of these sets or stages can be stacked adjacent one another to receive and condition a liquid desiccant in parallel. Each parallel stage of cold liquid channel, hot liquid channel, and condensation cell, includes multiple separate distillation stages arranged in series. Each distillation stage in series within each parallel stage of cold liquid channel, hot liquid channel, and condensation cell can be configured to improve the distillation of the liquid flowing through the system.

In an example, the hot channel of one parallel distillation stage of an example LDR system includes several evaporation chambers which are fluidly connected to one another in series. Each of these evaporation chambers correspond with one of several condensation chambers of the condensation cell located across the permeable membrane separating the hot liquid channel and evaporation chambers from the condensation cell. The combination of condensation chamber and corresponding evaporation chamber defines a serial distillation stage. Example serial distillation stages can have distinct physical properties, e.g., distinct temperatures, vapor pressures, desiccant concentrations, flow paths, shapes, and sizes, as examples. Such systems employing several distillation stages may increase moisture removal and improve energy efficiency compared to conventional membrane distillation techniques. Example LDR units and systems of the present disclosure can reduce the operating cost of a conditioning system and can minimize electrical power consumption and/or water consumption of the system.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present disclosure.

FIG. 1A schematically depicts an example liquid desiccant regenerator in accordance with this disclosure.

FIG. 1B schematically depicts an example liquid desiccant regenerator in accordance with this disclosure.

FIG. 1C schematically depicts an example liquid desiccant regenerator in accordance with this disclosure.

FIG. 2A and FIG. 2B are perspective and detail views depicting an example liquid desiccant regenerator system in accordance with this disclosure.

FIG. 3 is an exploded view depicting an example liquid desiccant unit the liquid desiccant regenerator system of FIGS. 2A and 2B.

FIG. 4 is a perspective view depicting an example of a cold panel of a liquid desiccant regenerator in accordance with this disclosure.

FIG. 5A is a perspective view depicting an example of a hot panel of a liquid desiccant regenerator in accordance with this disclosure.

FIG. 5B is a perspective view depicting an example of a hot panel of a liquid desiccant regenerator in accordance with this disclosure.

FIGS. 6A and 6B are perspective and detail views depicting an example of a condensation panel of a liquid desiccant regenerator in accordance with this disclosure.

### DETAILED DESCRIPTION

The present application relates to apparatuses and methods for membrane distillation (MD). For example, the present application relates to apparatuses and methods for regenerating the concentration of a liquid desiccant for recycled use in a conditioning system.

The inventor(s) have conceived a new design for a multi-stage membrane air gap membrane distillation (AGMD) apparatus. The membrane distillation apparatuses are generally referred to herein as liquid desiccant regenerator (LDR) units or systems. However, example LDR units and systems can be used with aqueous solutions other than liquid desiccant, e.g., salt water, sea water, brackish water, or recycled wastewater. Example LDR systems in accordance with this disclosure can include one or more LDR units, and the LDR units can be stacked or layered. Example LDR units can also be vacuum-assisted MD (VAGMD) apparatuses and can utilize continuous or intermittent suction of the air gap. Example LDR units and systems in accordance with this disclosure are configured to distill a dilute liquid solution, e.g., liquid desiccant, to separate liquid water and create a concentrated liquid solution, e.g., concentrated liquid desiccant.

Multi-stage membrane distillation can elsewhere simply refer to a distillation process involving multiple sequential phases of membrane distillation, and each phase can be necessary for membrane distillation. However, herein “multi-stage” membrane distillation refers to the series of distillation stages which are each independently capable of complete membrane distillation including evaporation and condensation at each stage. Each distillation stage can have properties and/or structural characteristics that are different than other stages. For example, each serial distillation stage can have temperature and/or vapor pressure that is different than other serial stages, and each stage can have a volume that is different than other serial stages. For example, in a series of distillation stages within a single LDR unit of an LDR system, which includes a hot liquid channel, cold liquid channel, and condensation chamber, each serial distillation stage of the hot liquid channel can have a volume that is larger than that of a preceding stage. In this manner, a single LDR unit of the present disclosure has multiple stages configured to operate in series, and several multi-stage LDR units can be stacked or layered to form an LDR system and configured to run in, e.g., a parallel configuration. Example apparatuses or methods of the present disclosure can be used in conditioning systems (e.g., cooling, heating, humidification/dehumidification) to help regenerate concentrated liquid desiccant which has been diluted by the system. Example apparatuses or methods of the present disclosure can also be used by, e.g., conditioning systems to purify and recover liquid water used by the system.

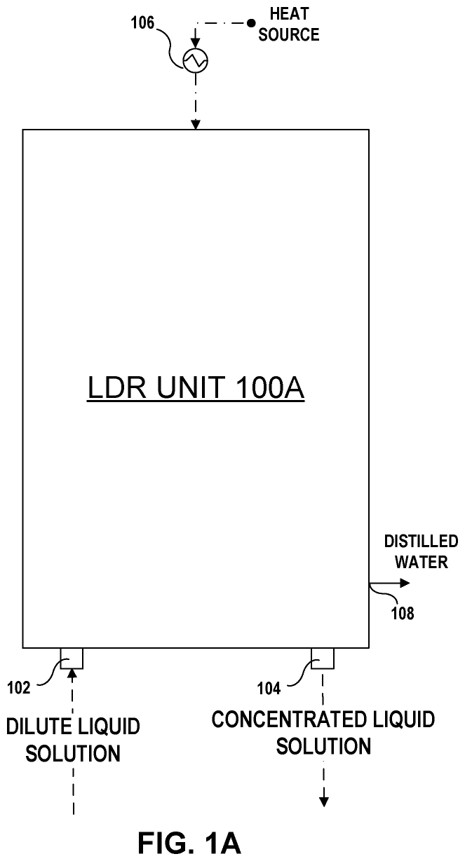

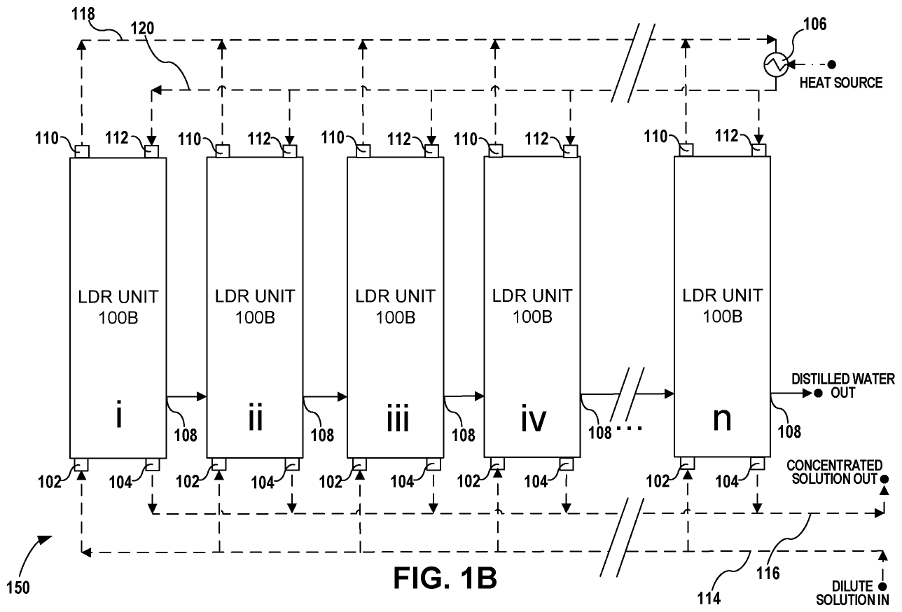

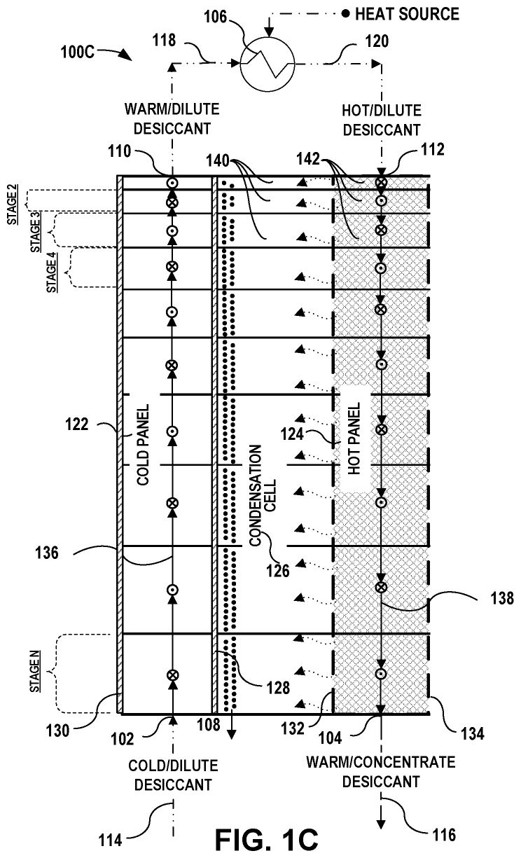

FIG. 1A depicts example LDR unit 100A in accordance with examples of this disclosure. LDR unit 100A can be employed for a variety of practical applications and in combination with various other HVAC components and/or systems. Generally speaking, LDR unit 100A functions to remove water from a dilute solution, thereby increasing the salt concentration of the dilute solution exiting the LDR unit 100A. The concentrated solution exiting the LDR unit 100A can be recirculated to a conditioning system to be used, e.g., for evaporative cooling. In some examples, the water exiting the recovered water outlet 108 can be collected and used as purified water either as a primary or secondary objective of the system.

LDR unit 100A is structured, arranged, and configured to distill liquid water from a liquid solution. In this example, LDR unit 100A includes a liquid solution inlet 102, a liquid solution outlet 104, an energy input 106, and a recovered water outlet 108. The LDR unit 100A functions to perform membrane distillation of a relatively dilute liquid solution entering at the liquid solution inlet 102 which results in the production of both a relatively concentrated liquid solution exiting at the liquid solution outlet 104 and distilled water exiting at the recovered water outlet 108. In some examples as described herein, the LDR unit 100A is configured primarily to regenerate salt concentration of the liquid solution while producing distilled water as a by-product. In other examples, the LDR unit 100A is configured primarily to produce purified or distilled water while generating, e.g., a brine or waste solution as a by-product. Regardless, either or both the concentrated liquid solution from liquid solution outlet 104 and the distilled water from recovered water outlet 108 can be used as products in the examples of the present disclosure.

Example liquid solutions can be liquid desiccants which are used by, e.g., a larger conditioning system which is configured to provide cooling to a heat load. In an example, liquid desiccant is cycled through components of the conditioning system to modulate the water content and/or temperature of air or a liquid cycling through the conditioning system. Water vapor is rejected from, e.g., supply air or a cooling liquid and into the liquid desiccant. Liquid desiccant can be used by several conditioning system components such as, e.g., an evaporative cooler or desiccant dryer to modulate the temperature and/or moisture content of air or a liquid. As liquid desiccant is cycled through such a conditioning system, it becomes diluted and loses the ability to provide sufficient drying/cooling. LDR unit 100A functions to restore the concentration of a liquid desiccant after it collects water from the cooling liquid or air as a result of, e.g., evaporative cooling within the conditioning system. LDR unit 100A is structured and configured to receive dilute desiccant at the liquid solution inlet 102, draw water out of the desiccant, and channel the concentrated (regenerated/restored) desiccant and recovered water out of the LDR unit 100A at a liquid solution outlet 104.

For example, LDR unit 100A can be configured to receive the liquid desiccant at the liquid solution inlet 102 and separate the water and desiccant into a concentrated desiccant stream, which exits LDR unit 100A at outlet 104, and a water stream, which exits the LDR unit 100A at recovered water outlet 108. The water recovered by LDR unit can be used as a pure water supply by other components of the conditioning system such as to reduce overall water consumption of the system, and/or stored in a tank or other reservoir.

The dilute desiccant entering LDR unit 100A can have a first desiccant concentration C1. The desiccant at the first concentration C1 can be regenerated in LDR unit 100A such that a second concentration C2 of the desiccant exiting LDR unit 100A can be markedly greater than the first concentration C1.

LDR unit 100A can include a variety of devices structured and configured to separate liquid water from the liquid desiccant. For example,

LDR unit 100A can be a thermally driven brine concentration device/system. In examples, LDR unit 100A is a vacuum multi-effect membrane distillation device, which is configured to employ heat to distill the desiccant solution flowing there through. LDR unit 100A can also include other types of devices, including, for example, electro dialysis, reverse osmosis (RO) filtration, a gas boiler with condenser, a vacuum assisted, multi-stage flash, or other membrane distillation devices other than a vacuum multi-effect membrane distillation device.

The type of energy input 106 to LDR unit 100A can include, for example, electrical power, mechanical power, or heat. The type of energy input 106 may depend on the technology used for regeneration of the liquid desiccant. Although the LDR unit 100A is shown as a single unit in FIG. 1A, the LDR unit 100A can represent more than one device. For example, an LDR system can include a heat recovery unit upstream of the LDR unit.

LDR unit 100A can include energy input 106 to facilitate separation of water and liquid solution, e.g., by heating the liquid solution within a portion of the LDR unit 100A to, e.g., help stimulate vapor transfer between panels/cells within the LDR unit 100A. In some examples, energy input 106 can be supplied by recycled or waste heat from another component of a larger conditioning system. In other examples, energy input 106 can be supplied by solar heat, heat or steam provided by a boiler, a heat exchanger, or a relatively high-grade heat source to help improve the thermal performance and water recovery efficiency of LDR unit 100A. In some examples, conditioning systems in accordance with this disclosure can use relatively low concentration liquid desiccants to absorb water vapor from a cooling liquid or air, which can be particularly beneficial in terms of the energy efficiency of conditioning systems. In such cases, a relatively low load on LDR unit 100A can allow for an energy input 106 (e.g., supplied by a heat source) to LDR unit 100A to be a lower grade source, e.g., recycled heat or waste heat from another component of a conditioning system.

Example energy inputs 106 can be supplied by the heat source being recovered waste heat from a heat load (e.g., a data center), the heat load being the primary cooling recipient of the conditioning system. For example, a conditioning system can include a cooling liquid which is cycled to reject heat from the heat load. The cooling liquid exiting the heat load can be completely or partially supplied to the energy input 106 of LDR unit 100A to reject heat to the LDR unit 100A utilizing, e.g., a liquid-to-liquid heat exchanger (LLHX). In another example, the heat load can include multiple hot cooling liquid circuits, including a first circuit with the cooling liquid at a first temperature and a second circuit with the cooling liquid at a second temperature greater than the temperature of the cooling liquid flowing through the first circuit. This type of dual-circuit liquid return is prevalent in certain types of heat loads such as data centers where, e.g., heat is rejected to the cooling liquid from two distinct portions having differing cooling requirements or heat outputs. The second circuit having the greater temperature (i.e., the second cooling liquid return circuit) can be supplied directly to the energy input 106 for rejecting heat to the LDR unit 100A before merging with the first cooling liquid circuit to be supplied to other components of the conditioning system. Since the second cooling liquid return circuit rejects heat to the energy input 106, the temperature difference between each of the first circuit and the second circuit can be mitigated prior to merging and before use of the cooling liquid for, e.g., evaporative cooling elsewhere in the conditioning system.

In another example, the liquid solution entering the LDR unit 100A is an aqueous solution such as, e.g., salt water or blowdown water from a conditioning system. Here, LDR unit 100A is used to separate purified water from a relatively dilute liquid solution and discard a relatively concentrated liquid solution.

FIG. 1B schematically depicts example LDR system 150 in accordance with examples of this disclosure. The LDR system 150 includes several LDR units 100B which are substantially similar to LDR unit 100A and LDR unit 100C, described below with reference to FIG. 1C. The components, structures, configurations, functions, etc. of LDR units 100B can therefore be the same as or substantially similar to that described in detail with respect to LDR unit 100A and LDR unit 100C. Multiple LDR units 100B are run concurrently in the LDR system 150 to, e.g., produce a cumulative system output.

For example, in systems requiring a relatively high system output (i.e., rapid solution regeneration or high water production), several LDR units 100B are combined to spread a system load amongst each of the units 100B. Similarly, in systems requiring a relatively high thermal efficiency (i.e., low use of an energy input 106), LDR units 100B are stacked or layered to help retain heat within the system 150. As depicted in FIG. 1B, the LDR units 100B are fluidly connected in parallel at each of the liquid solution inlets 102 and the liquid solution outlets 104. In an example, dilute liquid solution enters a supply circuit 114 of the LDR system 150 and the supply circuit 114 feeds a bank of the liquid solution inlets 102. Likewise, concentrated liquid solution generated by the LDR units 100B exits each of the liquid solution outlets 104 and join a return circuit 116. The LDR units 100B have relatively equal thermodynamic properties as one another, e.g., temperatures, pressures, and volumes of the liquid solution therein. Also, the mass flow rate of the liquid solution through each LDR unit 100B is relatively equal across the LDR units 100B. Thus, each LDR unit 100B produces a substantially similar output of concentrated liquid solution from outlet 104 and distilled water from outlet 108. Distilled water exiting each of the LDR units 100B can be collected in series or in parallel before exiting the LDR system 150. Alternatively, the distilled water exiting each of the LDR units 100B at recovered water outlet 108 can exit the LDR unit separately for collection or use. The amount of LDR units 100B incorporated in the LDR system 150 can depend on, e.g., the system output requirements (i.e., concentrated solution generation or water production), a target system thermal efficiency, or the dilute liquid solution flow rate.

Similar to the LDR unit 100A, the LDR units 100B include energy input 106 to facilitate separation of water and desiccant, e.g., by heating the liquid desiccant within a portion of the LDR units 100B to, e.g., help stimulate vapor transfer within the LDR unit 100B. In an example, as depicted in FIG. 1B, the LDR units 100B are each connected in parallel to an energy supply circuit 118 and an energy return circuit 120. As depicted in FIG. 1B, liquid solution passes out a warm outlet 110 of each of the LDR units 100B to enter the energy supply circuit 118 in parallel. The energy supply circuit 118 supplies relatively cold liquid solution from each of the LDR units 100B to the energy input 106 for heating. The energy input 106 heats the liquid solution to feed a bank of hot inlets 112 of the LDR units 100B via the energy return circuit 120. Here, the heat distributed by the energy input 106 to the liquid solution entering each of the LDR units 100B is relatively equal. While FIG. 1B depicts a single energy input 106 fluidly connected to the energy supply circuit 118 and energy return circuit 120, multiple energy inputs 106 can be used to supply heated liquid solution to each of the LDR units in a parallel circuit. Example LDR systems 150 can include several energy inputs 106 at various locations along the energy supply circuit 118 or the energy return circuit 120.

The LDR units 100B are each capable of independent membrane distillation of the liquid solution and thus capable of independent production of concentrated liquid solution and distilled water. When combined in parallel in LDR system 150, the products of the cumulative membrane distillations in each of the units 100B combine to create a total concentrated solution production as well as a total distilled water production. In some examples utilizing adjacent LDR units 100B, the total concentrated solution production and the total distilled water production can be greater than a sum of the independent productions of the LDR units 100B in isolation. This can result from, e.g., greater vapor pressures due to collective heat conservation of the overall system 150. Such adjacent LDR unit embodiments will be discussed at greater length below.

FIG. 1C depicts example LDR unit 100C in accordance with examples of this disclosure. LDR unit 100C can be substantially similar to LDR unit 100A and LDR unit 100B of FIG. 1A and FIG. 1B, respectively. The components, structures, configurations, functions, etc. of LDR unit 100C can therefore be the same as or substantially similar to that described in detail above with reference to LDR unit 100A and LDR unit 100B. LDR unit 100C includes a liquid solution inlet 102, a liquid solution outlet 104, an energy input 106, and a recovered water outlet 108. LDR unit 100C also includes a cold panel 122, hot panel 124, and a condensation cell 126 interposed between adjacent cold panel 122 and hot panel 124. The LDR unit 100C functions to perform air gap membrane distillation AGMD of, e.g., a relatively dilute liquid solution to produce both a relatively concentrated liquid solution and liquid water. Herein, e.g., as depicted in FIG. 1C, the liquid solution can be referred to generally as liquid desiccant. However, example LDR units can be used with aqueous solutions other than liquid desiccant, e.g., salt water, sea water, brackish water, or recycled wastewater. In operation of LDR unit 100C, as liquid desiccant flows through hot panel 124, water vapor evaporates from the desiccant and migrates across a permeable membrane 132 and into the condensation cell 126. Example LDR systems in accordance with this disclosure can include a stack of adjacent cold panel-condensation cell-hot panel groups, as depicted and described with reference to the multiple LDR units 100B of LDR system 150 of FIG. 1B.

Cold panel 122 and hot panel 124 can be polymer panels formed of plastics suitable for use in conditioning systems. Each of panels 122 and 124 can define one or more liquid flow channels enclosed by a membrane. In some examples, the cold panel 122 can define one or more liquid flow channels enclosed by an impermeable membrane, film, or a coated metal plate. For example, the cold panel 122 includes liquid solution inlet 102 and first impermeable membrane 128. And the hot panel 124 includes liquid solution outlet 104 and a first permeable membrane 132. In examples in which an LDR system in accordance with this disclosure includes more than one stack of cold panel-condensation cell-hot panel groups, each hot panel 124 includes both first permeable membrane 132 and a second permeable membrane 134, each on opposite faces of and enclosing the hot liquid channel or channels housed by the panel 124. Also, in examples in which the LDR system includes more than one stack, each cold panel 122 includes both first impermeable membrane 128 and second impermeable membrane 130 on opposite faces of and enclosing the hot liquid channel or channels housed by the panel 122. Also, in some examples the cold panel 122 is enclosed on one or both sides by a wall of the cold panel 122 instead first impermeable membrane 128 or second impermeable membrane 130.

Dilute, relatively cold liquid desiccant is supplied to the LDR unit 100C via liquid solution inlet 102 and passed through one or more liquid channels in cold panel 122 to and out the warm outlet 110. Liquid desiccant entering the energy supply circuit 118 and exiting the cold panel 122 can be less concentrated than the liquid desiccant exiting the hot panel 124 at solution outlet 104. Also, liquid desiccant exiting the cold panel 122 can have a greater temperature than the liquid desiccant entering at liquid solution inlet 102 as heat from liquid desiccant traveling through the hot panel 124 can be rejected to desiccant in the cold panel 122.

In an example the liquid desiccant exits the cold panel 122 and enters the energy supply circuit 118 which supplies the liquid desiccant to the energy input 106. The energy input 106 then preheats the desiccant before entering the hot panel 124. The energy input 106 supplies a temperature difference (ΔT) or lift between desiccant in the cold panel 122 and the hot panel 124 to help stimulate membrane distillation. Preheating the liquid desiccant flowing through the hot panel 124 can be required for desired evaporation of water vapor in the hot panel 124 and condensation of the water vapor in the condensation cell 126 to occur. This is due to, e.g., the fact that salt solutions such as liquid desiccant have relatively low vapor pressures and are hygroscopic. Heating the desiccant can help increase the vapor pressure of the desiccant in the hot panel 124 and can help create a vapor pressure gradient across the permeable membrane 132. The temperature difference (ΔT) between the desiccant before and after being heated by the energy input 106 can range from about 15° C. to about 80° C. depending on, e.g., the grade of heat source provided to the energy input 106, the type of desiccant used, or the flow rate of the desiccant flowing through the LDR unit 100C. As previously described, the type of energy input 106 to the LDR unit 100C can include, for example, electrical power, mechanical power, or heat. In some examples, energy input 106 can be supplied by recycled or waste heat from another component of a larger conditioning system. In other examples, energy input 106 can be supplied by solar heat, geothermal heat, heat or steam provided by a boiler, a heat exchanger, or a relatively high-grade heat source to help improve the thermal performance and water recovery efficiency of LDR unit 100C.

In examples, the energy input 106 can supply between about 2 kilowatts (kw) to about 15 kw of energy to help heat the liquid desiccant. In an example, preheating of the liquid desiccant prior to entering the hot panel 124 is primarily due to heat supplied by the energy input 106. The desiccant can also be gradually pre-heated while flowing through the cold panel 122 as a result of, e.g., condensation of water vapor in the adjacent condensation cell 126 and rejection of heat from desiccant flowing through the hot panel 124. In other words, latent heat rejected by the preheated liquid desiccant as a result of membrane distillation is recovered by the liquid desiccant flowing through the cold panel 122. Additionally, any sensible heat rejected by the preheated liquid desiccant can be similarly recovered. In examples including stacks of cold panel-condensation cell-hot panel groups, the amount of latent and sensible heat recovered by the liquid desiccant flowing through the cold panels 122 is further increased since heat from each hot panel 124 is recovered by two cold panels, one on either side.

Relatively hot liquid desiccant is supplied to the hot panel 124 via energy supply circuit 118 and passed via the energy return circuit 120 to the hot panel 124. Liquid desiccant then travels through the hot panel 124 to liquid solution outlet 104. The relatively hot liquid desiccant can reject water vapor in passing through the hot liquid panel 124. In some examples, the relatively hot liquid desiccant can reject heat in passing through the hot liquid panel 124, and exits the LDR unit 100C as relatively cooled, concentrated liquid desiccant at liquid solution outlet 104.

The liquid channel or channels of cold panel 122 are enclosed by first impermeable membrane 128 located between cold panel 122 and condensation cell 126. While described herein as an impermeable membrane or film 128, the partition between cold panel 122 and condensation cell 126 can be other materials suitable for surface condensation of water vapor. In one example, the liquid channel or channels of the cold panel 122 are enclosed internally within the cold panel and configured for condensation directly onto a surface of the panel 122. The liquid channels of cold panel 122 can be structured and configured to direct liquid desiccant from inlet 102 to the energy supply circuit 118 along a variety of flow paths. As indicated in FIG. 1C, flow path 136 of cold panel 122 directs the desiccant through the panel in two directions, up and down (in and out of the page depicting the view of FIG. 1C) and from inlet 102 to energy supply circuit 118 in a serpentine path. Hot panel 124 includes a similar serpentine flow path 138 in the opposite direction as the flow through cold panel 122. However, in other examples according to this disclosure, hot and cold panel flow paths can be in the same direction from respective inlets to outlets. Also, cold panel 122 and hot panel 124 can include multiple serpentines, parallel, interdigitated, or other flow paths through one or multiple liquid channels.

LDR 100C includes condensation cells 126 which can include a plurality of air or vacuum condensation chambers 140. Condensation chambers 140 can function to insulate the cold panel 122 from the hot panel 124 to reduce sensible heat transfer therebetween and to improve vapor (mass) transfer across the permeable membranes of the panels, e.g., first permeable membrane 132 or second permeable membrane 134. Decreased (e.g., in the case of air-gap chambers) or negative (e.g., in the case of vacuum-gap chambers) air pressure in condensation chambers 140 can be maintained continuously or periodically during operation of LDR unit 100C.

For example, a continuous or intermittent vacuum can be applied to the condensation chambers 140 to maintain decreased or negative air pressure therein. Maintaining a decreased or negative air pressure can help remove non-condensable gas which evaporates from the liquid desiccant and into the chambers 140. Decreased or negative air pressure in the condensation chambers 140 can also help minimize sensible heat transfer between the hot panel and cold panel and thereby maximize moisture transfer between the first permeable membrane 132 and the impermeable membrane 128. The vacuum can be supplied by, e.g., one or more thermo-compressors or a vacuum generator. The vacuum pressure continuously or intermittently supplied can be, e.g., about 5 kPa.

In an example, the LDR unit 100C can be periodically shut down and vacuum pressure can be applied to restore the decreased or negative air pressure within the condensation chambers 140 without drawing out water vapor from the chambers 140. In another example, vacuum pressure can be applied to the LDR unit 100C while the unit 100C is performing membrane distillation, and water vapor, air, and liquid water can be drawn from the chambers and e.g., supplied to a reservoir or condenser.

In an example, the relatively hot liquid desiccant entering the hot panel 124 can have a significantly higher vapor pressure than the relatively cold liquid desiccant traveling through the cold panel 122. This can create a vapor pressure gradient across, e.g., first permeable membrane 132, and also across condensation chamber 140 located therebetween. As hot liquid desiccant flows from energy input 106 and through the hot panel 124 to the liquid solution outlet 104, water vapor migrates across, e.g., first permeable membrane 132 as a result of the vapor pressure gradient. Water vapor entering the condensation chamber 140 subsequently condenses within the cell on, e.g., the impermeable membrane 128 which borders the condensation chamber 140. Condensed liquid water is collected within the condensation cell 126 and exits the LDR unit 100C at recovered water outlets 108. As membrane distillation occurs across the first permeable membrane 132 and within the condensation chamber 140, the temperature of the liquid desiccant remaining within the hot panel 124 is decreased. As such, the temperature of the liquid desiccant at liquid solution outlet 104 is lower than the temperature of the liquid desiccant supplied by the energy return circuit 120.

While membrane distillation of LDR unit 100C is generally described as occurring across permeable membrane 132, membrane distillation can additionally and concurrently be occurring across the permeable membrane 134 in examples where, e.g., the hot panel 124 is bordered on both sides by each of a condensation cell and a cold panel. Consequently, while membrane distillation of LDR unit 100C is generally described as resulting in condensation of liquid water on, e.g., the first impermeable membrane 128, condensation of liquid water can additionally and concurrently be occurring across the impermeable membrane 130 in examples where, e.g., the cold panel 122 is bordered on both sides by each of a condensation cell and a hot panel. In other words, each hot panel 124 can concurrently supply water vapor from liquid desiccant flowing therethrough to two condensation cells, and each cold panel 122 can concurrently serve two condensation cells to help enable condensation therein.

To improve performance of LDR unit 100C (and other apparatuses in accordance with this disclosure), cold panel 122, hot panel 124, and condensation cell 126 can include multiple stages in series relative to the flow of liquid through LDR unit 100C. For example, the multiple stages of the LDR unit 100C can help reduce a liquid pressure differential across the permeable membrane 132 which can help reduce clogging or waterlogging of the membrane 132, reduce mechanical loads on the membrane 132, and thereby reduce the need to maintain or repair the membrane 132. Also, the multiple stages can improve thermal efficiency, enhance structural support, enhance the rate of desiccant regeneration, enhance distilled water production, and reduce deflections or bulging of the membranes e.g., membranes 132, 134, and 128.

In an example, the hot panel 124 can include evaporation chambers 142 which can each correspond to one of the condensation chambers 140. As depicted in FIG. 1C, a pair of adjacent evaporation chambers 142 and condensation chambers 140 can define a distillation stage. As liquid desiccant travels through the flow path 138 of the hot panel 124 and thus through each of the evaporation chambers 142 which are fluidly connected in series, the liquid desiccant undergoes several stages or phases of membrane distillation. The distillation stages are each independently capable of complete membrane distillation, and each of the distillation stages can have different thermodynamic and/or structural properties therein. In the case of condensation chambers 140, the stages can be physically separated/isolated from one another and can therefore certain parameters of the conditions in each of the chambers can be independently controlled. The performance of LDR unit 100C, e.g., the thermal efficiency, regeneration rate, or water production in various conditions and in combination with various other conditioning systems can be enhanced by varying a number of parameters of the serial stages of the device.

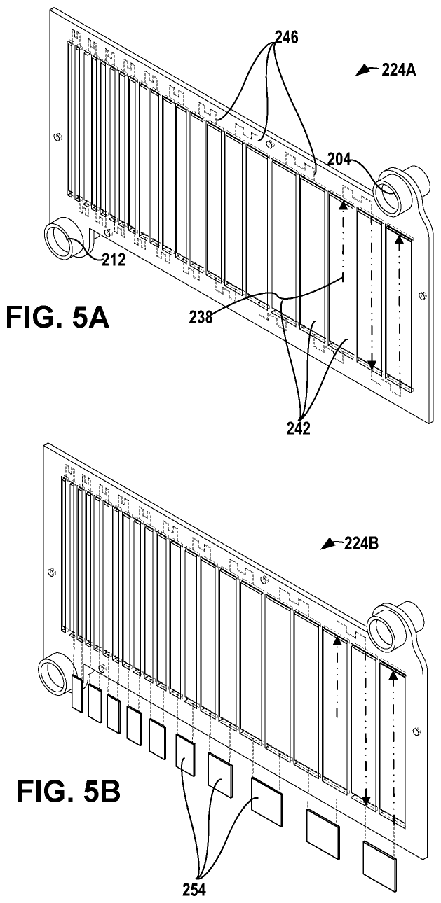

For example, vapor pressure in different stages of the air or vacuum condensation chambers 140 can be varied across LDR unit 100C (i.e., adjacent to the flow path 138 of the hot panel 124). In an example, each distillation stage has progressively lower vapor pressures in each of the condensation chambers 140 from an inlet 112 of the hot panel 124 to the liquid solution outlet 104 of the hot panel 124. Additionally, the size of each stage can be varied, as is schematically depicted in the example of FIG. 1C. LDR units described herein utilize a vapor pressure differential across permeable membrane 132 which is driven by the temperature difference AT of the desiccant between the cold panel and the hot panel. This vapor pressure differential creates a flux of mass across the membrane and enables membrane distillation to occur in the LDR unit. However, other pressure differentials within the LDR unit which do not aid membrane distillation can be mitigated or eliminated. In an example, the liquid pressure of the desiccant in the evaporation chamber 142 can be controlled by, e.g., varying the size and path of flow path 138 to be relatively equal to the vapor pressure in the adjacent condensation chamber 140. Reducing or mitigating a pressure differential by controlling the liquid pressure of the desiccant travelling through each evaporation chamber 142 of the distillation stages can help reduce strain, clogging, bulging, or degrading of the membrane 132 and can increase membrane longevity. The difference in pressure between the liquid pressure of the desiccant in the evaporation chamber 142 and the vapor pressure in the adjacent condensation chamber 140 can be less than about 60 kPa. Examples including a flow path 138 of the hot panel 124 designed to mitigate unnecessary pressure differentials across the membrane 132 will be discussed further below with respect to FIG. 5A.

The permeable membranes of LDR unit 100C, e.g., first permeable membrane 132 and second permeable membrane 134, can be structured and configured to be permeate gas and vapor, but to prevent permeation of liquids and solids from the cooling liquid. Thus, generally anything in the cooling liquid in a gas phase can pass through the membranes and generally anything in a liquid or solid phase cannot pass through the membranes. Such membranes can include porous, micro-porous, non-porous, and selectively permeable membranes, as examples. In examples, the membranes of example LDR units and systems in accordance with this disclosure can be a micro-porous structure membrane formed as a thin film of a low surface energy polymer such as PTFE, polypropylene or polyethylene. The hydrophobic membrane resists penetration by the liquid due to surface tension, while freely allowing the transfer of gases, including water vapor, through the membrane pores. In examples, the membranes can be about 20 microns thick with a mean pore size of 0.1-0.2 micron.

The impermeable membranes of the adjacent liquid panels of the LDR unit 100C, e.g., first impermeable membrane 128 and second impermeable membrane 130, can be formed of any type of impermeable material suitable for use with the liquid solution. In an example, the impermeable membrane can include one or more polymers. The polymers can include, e.g., polyester, polypropylene, polyethylene (including high density polyethylene), nylon, polyvinyl chloride, polytetrafluoroethylene, and polyetheretherketone. In an example, the impermeable membrane can be formed of one or more metals or metal alloys. The metals can include any kind of conductive metal, including, e.g., aluminum, copper, stainless, nickel, titanium, cupronickel, and combinations thereof. A thickness of the impermeable membrane can range between about 0.025 mm to about 1 mm. Example impermeable membranes can be sufficiently thin such that the membranes, e.g., membrane 128, can provide low resistance to heat transfer and thus help maximize latent heat transfer within the LDR unit 100C while limiting sensible heat transfer.

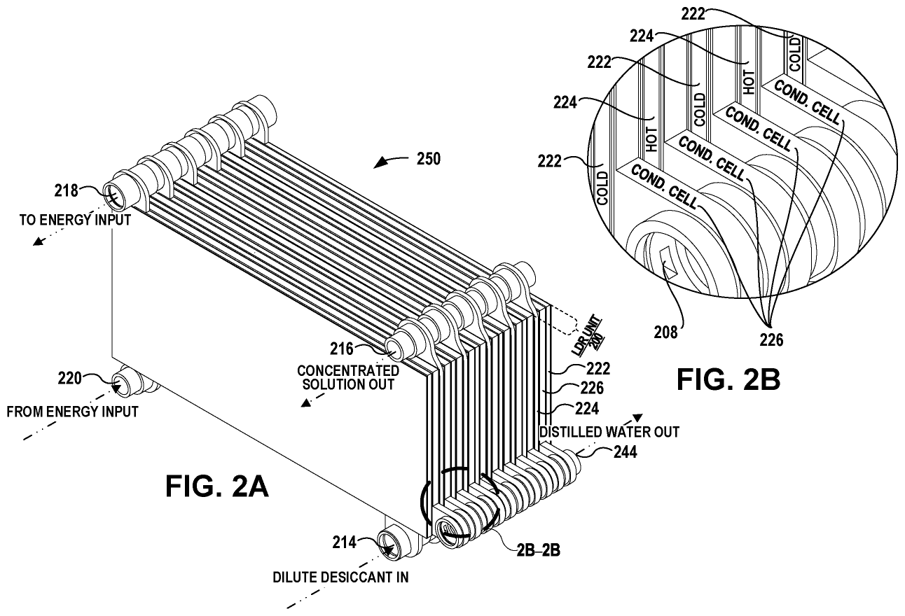

FIG. 2A and FIG. 2B are perspective and detail views depicting example LDR system 250 in accordance with this disclosure. Similar to LDR system 150, the LDR system 250 includes several LDR units 200 which can be substantially similar to LDR unit 100A, LDR unit 100B, and LDR unit 100C as previously described. The components, structures, configurations, functions, etc. of LDR System 250 can therefore be the same as or substantially similar to that described in detail with respect to LDR system 150.

In the example of FIGS. 2A and 2B, multiple LDR units 200 are run concurrently in the LDR system 250 to, e.g., produce a cumulative system output. For example, in systems requiring a relatively high system output (i.e., rapid desiccant regeneration or high water production), several LDR units 200 are layered or stacked to spread a system load amongst each of the units 200. Similarly, in systems requiring a relatively high thermal efficiency (i.e., low use of an energy input), LDR units 200 are stacked or layered to help retain heat within the system 250.

Similar to that previously described with respect to LDR system 150, LDR system 250 includes LDR units 200 which are fluidly connected in parallel at a system supply inlet 214 and a system return outlet 216. The LDR units 200 each include a cold panel 222, a hot panel, 224, and a condensation cell 226 located therebetween. Dilute liquid desiccant enters the system supply inlet 214 of the LDR system 250 which feeds a bank of the liquid desiccant inlets of the cold panels 222. Concentrated liquid desiccant exits the system return outlet 216 supplied by a bank of liquid desiccant outlets of the hot panels 224. Also, distilled water exits a system water outlet 244 supplied by a bank of recovered water outlets of the condensation cells 226.

In an example depicted in FIG. 2A, the inlets/outlets of individual panels in system 250 can be sized and shaped to pair or mate with other inlets/outlets of corresponding panels to create, e.g., a tube or conduit to serve a bank of inlets/outlets in parallel. As depicted in FIG. 2A, the inlets/outlets between corresponding panels can pair or mate to form a single system connection point for transport of supply dilute desiccant, return concentrated desiccant, or distilled water output. Other examples can include multiple system connection points for similar liquid transport. The inlets/outlets between corresponding panels can also form a conduit to connect with an energy input for heating the desiccant at energy supply outlet 218 and energy return inlet 220.

The LDR units 200 have relatively equal thermodynamic properties as one another, e.g., temperatures, pressures, and volumes of the liquid solution therein. Also, the mass flow rate of the liquid solution through each LDR unit 200 is relatively equal across the LDR units 200. Thus, each LDR unit 200 produces a substantially similar output of concentrated liquid desiccant. Distilled water exiting each of the LDR units 200 at a recovered water outlet 208 (as depicted in FIG. 2B) can be collected in parallel in, e.g., a conduit before exiting the LDR system 250 at the system water outlet 244. The amount of LDR units 200 incorporated in the LDR system 250 can depend on, e.g., the system output requirements (i.e., concentrated solution generation or water production), a target system thermal efficiency, or the dilute liquid solution flow rate.

LDR units 200 are connected to an energy input at, e.g., energy supply outlet 218 and energy return inlet 220 to facilitate separation of water and desiccant, e.g., by pre-heating the liquid desiccant flowing through the hot panel 224 to, e.g., help stimulate vapor transfer within the LDR unit 200. Here, the heat distributed by the energy input to the liquid desiccant entering each of the LDR units 200 is relatively equal.

In another example, a separate fluid flows into the supply inlet 214 and through the cold panels 222 than the liquid desiccant. Here, the dilute desiccant is not distributed to the cold panels 222 for preheating or to help stimulate the membrane distillation process. Instead, the separate fluid flows into the LDR system 250 at the supply inlet 214 and out of the LDR system 250 at the supply outlet 218. The separate fluid functions to provide the cooling benefits to the LDR system 250 as previously described with respect to the cold dilute desiccant. Here, however, the separate fluid is “preheated” instead of the desiccant but is discarded or cycled out of the system 250 at supply outlet 218. The separate fluid can be cooled by an external cooler after exiting the supply outlet 218 and returned to the supply inlet 214 for recurrent use.

The LDR units 200 are each capable of independent membrane distillation of the liquid solution and thus capable of independent production of concentrated liquid solution and distilled water. When combined in parallel in LDR system 250, the products of the cumulative membrane distillations in each of the units 200 combine to create a total concentrated solution production as well as a total distilled water production. In examples utilizing adjacent LDR units 200, as depicted in FIG. 2A, the total concentrated solution production and the total distilled water production can be greater than a sum of the independent productions of the LDR units 200 in isolation. This can result from, e.g., greater vapor pressures due to collective heat conservation of the overall system 250.

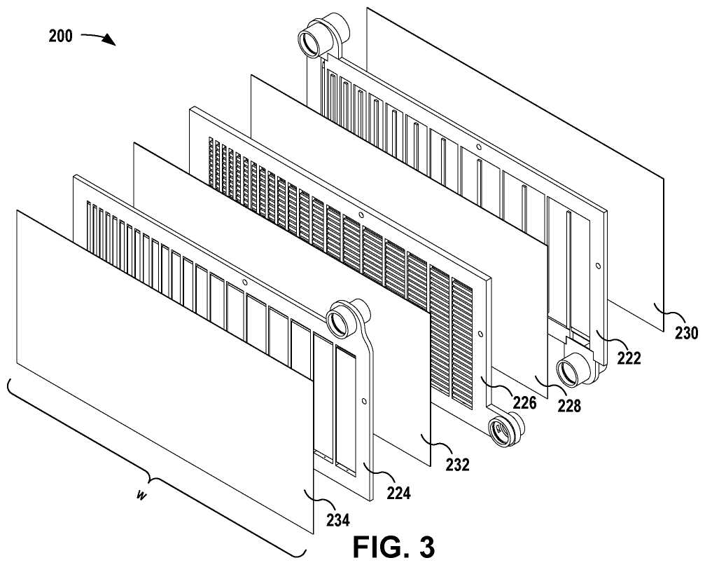

FIG. 3 depicts an exploded view of the example LDR unit 200 of FIGS. 2A and 2B. The LDR units 200 each include a cold panel 222, a hot panel, 224, and a condensation cell 226 located therebetween. Each hot panel 224 includes both first permeable membrane 232 and a second permeable membrane 234, each on opposite faces of and enclosing a hot liquid channel or channels housed by the panel 224. Also, each cold panel 222 includes both first impermeable membrane 228 and second impermeable membrane 230 on opposite faces of and enclosing a hot liquid channel or channels housed by the panel 222. Alternatively, or additionally the cold panel 222 can be enclosed on one or both sides by an integral a wall of the cold panel 222 versus by a separate membrane component.

As previously described, the LDR unit 200 includes multiple serial distillation stages, and each of the serial distillation stages are capable of independent membrane distillation. The serial distillation stages, which can each have different properties and/or structural characteristics, are employed by the LDR unit 200 to progressively remove liquid water from a dilute desiccant stream. Multiple LDR units 200 can be run concurrently in an LDR system to, e.g., produce a cumulative system output.

As depicted in FIG. 3, the LDR unit 200 can be constructed of multiple panels interposed between multiple membranes. Any of the cold panel 222, the hot panel 224, or the condensation panel 226 can be formed of plastic or polymer, e.g., polyetherimide (PEI) or polyether ether ketone (PEEK). Each panel can include multiple chambers. As depicted, the chambers in each respective panel can have different properties, e.g., size or shape, and in an example the chambers can be progressively larger or progressively smaller along the flow path through each respective channel. The progressively larger or progressively smaller chambers can be, e.g., aligned such that chambers of two or more of the panels correspond with one another.

In some examples, the corresponding chambers of two or more panels are arranged such that each of the corresponding chambers are adjacent to one another opposite one of the membranes. Corresponding evaporation chambers between the hot panel 224 and the condensation panel 226 can define or comprise a single distillation stage. In an example depicted in FIG. 3, the cold panel 222 the hot panel 224, and the condensation panel 226 each include a plurality of chambers (i.e., supply chambers, evaporation chambers, and condensation chambers, respectively). In other example LDR units, only the respective chambers of the hot panel 224 and the condensation panel 226 correspond with each. The serial chambers of each of the respective panels are sized and shaped such that the chambers align with one another along a width (w) of the LDR unit 200. In the depiction, the corresponding chambers each increase in size (i.e., volume) from left-to-right along the width of the LDR unit 200.

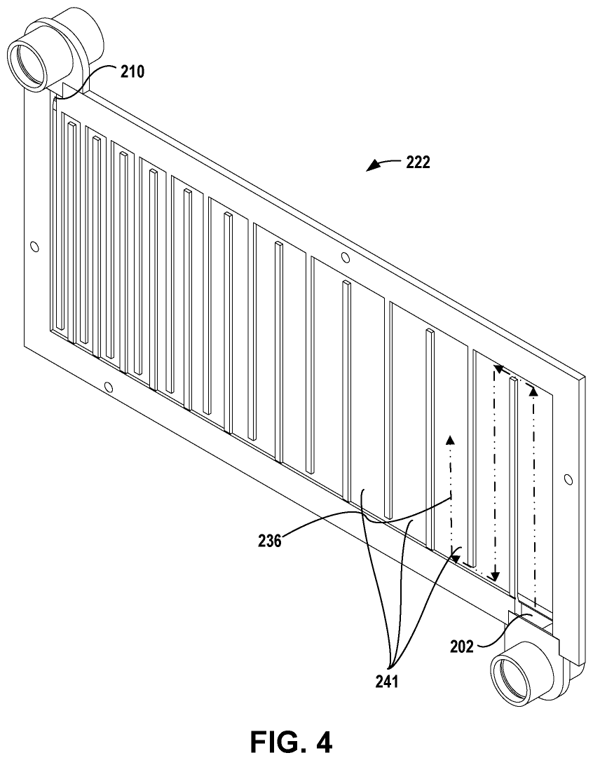

FIG. 4 depicts an isometric view of an example of a cold panel of an LDR unit in accordance with this disclosure. In an example, the cold panel 222 includes supply chambers 241, each of which correspond to a chamber of the hot panel 224 and a chamber of the condensation panel 226. In another example, the cold panel 222 does not include distinct supply chambers 241 or does not include supply chambers which correspond to chambers of the hot panel 224 or the condensation panel 226. In the example depicted in FIG. 4, the supply chambers 241 of the cold panel are serial chambers which are enclosed by impermeable membranes 228 and 230 (as depicted in FIG. 3) and define flow path 236 of cold panel 222. The flow path 236 directs desiccant through the cold panel 222 in two directions, up and down and from a cold panel inlet 202 to a cold panel outlet 210 in a serpentine path. Similar to that previously described with respect to the cold panel 122, dilute desiccant flows through the cold panel 222 from cold panel inlet 202 to cold panel outlet 210 in flow path 236. The liquid desiccant is preheated along flow path 236 by, e.g., condensation heat released on impermeable film 228 as a result of condensation in the condensation panel 226 (as depicted in FIG. 3), and as such the desiccant exits the cold panel 222 at the cold panel outlet 210 at a higher temperature than the desiccant at the cold panel inlet 202. In an example, the dilute desiccant is preheated along flow path 236 from about 30° C. to about 100° C. at least in part from condensation heat released on impermeable film 228.

In an example, the LDR unit 200 includes serial coolers located along the flow path 236 of the cold panel 222. The serial coolers can lower the temperature of the dilute desiccant flowing through the cold panel 222. In an example, the serial coolers can help mitigate a temperature increase of the dilute desiccant along the flow path 236 caused by the condensation heat. Here, the serial coolers can lower a temperature difference of the dilute desiccant at the cold panel inlet 202 and the cold panel outlet 210. In some examples, the serial coolers can be arranged, e.g., along the supply chambers 241, and the serial coolers can maintain a relatively constant temperature of the dilute desiccant traveling along the flow path 236. For example, the serial coolers can maintain the temperature of the dilute desiccant between a range of less than about ±10° C. along the flow path 236. Maintaining the relatively cold temperature of the dilute desiccant in the cold panel using the serial coolers can help lower the load on an energy input or external heater or can help increase a rate of water removal from the desiccant in the LDR unit 200. In another example, the cold panel 222 includes a secondary flow path for a cooling fluid. The second flow path can cycle the cooling fluid through the cold panel 222 to lower the temperature of the dilute desiccant traveling along the flow path 236 of the cold panel 222. The cooling fluid can be cooled by an external cooler and can help lower the load on an energy input or external heater or can help increase a rate of water removal from the desiccant in the LDR unit 200.

FIG. 5A depicts an isometric view of an example of a hot panel of an LDR unit in accordance with this disclosure. In an example, the hot panel 224A includes evaporation chambers 242, each of which correspond to a chamber of the cold panel 222 or a chamber of the condensation panel 226. In the example depicted in FIG. 5A, the evaporation chambers 242 of the hot panel 224A are serial chambers which are enclosed by permeable membranes 232 and 234 (as depicted in FIG. 3) and define flow path 238 of hot panel 224A. The flow path 238 directs desiccant through the hot panel 224A in two directions, up and down and from a hot panel inlet 212 to a hot panel outlet 204 in a serpentine path. Similar to that previously described with respect to the hot panel 124, as dilute desiccant travels along flow path 236, water vapor is removed from the desiccant stream and travels across permeable membrane 232 and into the condensation panel 226 (as depicted in FIG. 3). Such a transfer of water vapor can occur out of each of the evaporation chambers 242 and into each of the condensation chambers 240 (as depicted in FIG. 7). As such, the concentration of the desiccant is higher at the hot panel outlet 204 than the concentration of the desiccant at the hot panel inlet 212. Also, the evaporation chambers 242 can be progressively larger from the hot panel inlet 212 to the hot panel outlet 204 and the vapor pressure within each the evaporation chambers 242 can be progressively smaller. In an example, the vapor pressure in the first evaporation chamber at or near the hot panel inlet 212 is higher than the vapor pressure in the last evaporation chamber at or near the hot panel outlet 204. For example, the vapor pressure at the first evaporation chamber can be about 130 kPa and the vapor pressure at the last evaporation chamber can be within a range of about 3 kPa to 9 kPa, and the vapor pressure at a plurality of evaporation chambers between the first evaporation chamber and the last evaporation chamber can be subsequently lowered, e.g., in intervals between the first and last evaporation chambers. In an example, the evaporation chambers can be sized and shaped e.g., in intervals such that each subsequent chamber has a vapor pressure of about 7 kPa less than the preceding chamber.

The hot panel 224A can also include internal orifice channels 246 between the evaporation chambers 242. The internal orifice channels 246 can help mitigate a challenge in some approaches to membrane distillation of the liquid side pressure in the evaporation chamber being higher than the vapor pressure in the condensation chamber. The internal orifice channels 246 can have reduced dimensions compared to the volume of each evaporation chamber 242, and the internal orifice channels 246 can function to help reduce the liquid side pressure in the evaporation chambers 242 of the hot panel 224A. In an example, the internal orifice channels 246 can help reduce the liquid side pressure in the evaporation chamber 242 to be slightly higher than a vapor pressure in its corresponding condensation chamber 240 (within the condensation cell 226 as depicted in FIG. 3. Other features can be included alternatively or additionally to help reduce liquid side pressure in the evaporation chambers 242 of the hot panel, such as, e.g., a needle or pin valve.

In an example as depicted in FIG. 5B, the hot panel 224B can include or use serial heaters 254 at one or more of the individual stages in the hot solution channel. In this way, the moisture transfer rate in each stage could be made more uniform without requiring extra special design, such as varying cell transfer area. The heat input from the serial heaters 254 can be made at each stage in varying amounts. Also the serial heaters 254 can only be included at certain stages such as to periodically to “boost” the lower temperature stages. Also, the serial heaters 254 can help recover some of the heat lost in the condensate water, since the temperature of condensate water in some stages could be up to 100° C.

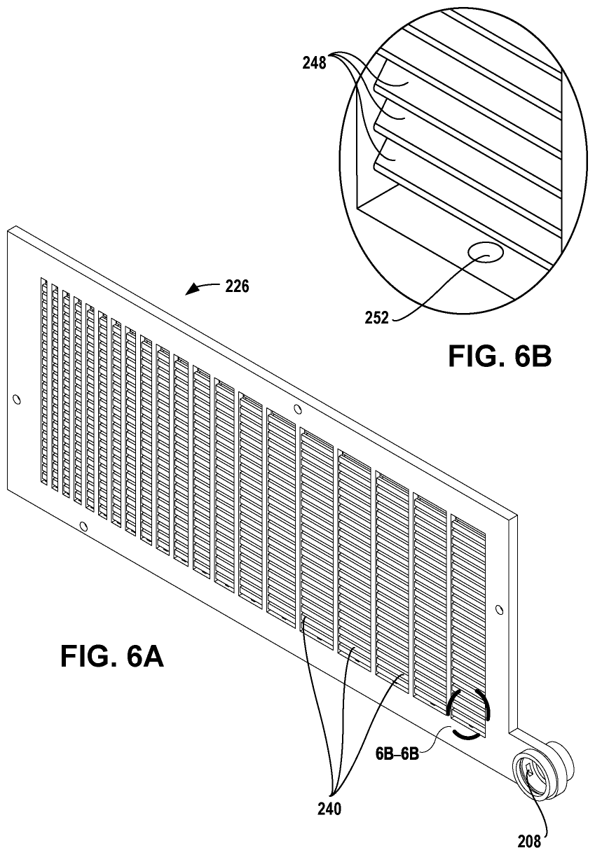

FIG. 6A and FIG. 6B depict an isometric view of an example of a condensation panel of an LDR unit in accordance with this disclosure. In an example, the condensation panel 226 includes condensation chambers 240, each of which correspond to a chamber of the cold panel 222 or a chamber of the hot panel 224. In the example depicted in FIG. 6A, the condensation chambers 240 of the hot panel 224 are enclosed by a permeable membrane 232 and an impermeable membrane 228 (as depicted in FIG. 3). Water vapor passes through the permeable membrane 232 and into the condensation chambers 240, and the water vapor condenses on the impermeable membrane 228 at least partially due to the cooling provided to the impermeable membrane 228 by the cold panel 222 (as depicted in FIG. 3). In an example as depicted in FIG. 6A, the condensed fluid can drip or run down the impermeable membrane 228 in each condensation chamber 240 and be collected e.g., through a collection orifice 252 of the condensation chamber 240. The collection orifices 252 can feed into a collection channel of the condensation panel 226, and the collection channel can feed into the recovered water outlet 208.

The condensation chambers 240 can be progressively smaller from right-to-left (i.e., in the order corresponding to the flow path 238 of the hot panel 224) in the depiction in FIG. 6A. Likewise, the vapor pressure within each the condensation chambers 240 can be progressively smaller. In an example, the vapor pressure in the first condensation chamber (corresponding to the first evaporation chamber) is higher than the vapor pressure in the last condensation chamber (corresponding to the last evaporation chamber). For example, the vapor pressure at the first condensation chamber can be about 100 kPa and the vapor pressure at the last condensation chamber can be within a range of about 1 kPa to 6 kPa, and the vapor pressure at a plurality of condensation chambers between the first condensation chamber and the last condensation chamber can be subsequently lowered e.g., in intervals between the first and last condensation chambers. In an example, the condensation chambers 140 can be sized and shaped, e.g., in intervals such that each subsequent chamber has a vapor pressure of about 7 kPa less than the preceding chamber. The vapor pressure in the condensation chambers 140 can be lower than the vapor pressure in each of the respective corresponding evaporation chambers 142, and the vapor pressure difference between corresponding condensation chambers 140 and evaporation chambers 142 can be within a range of about 2 kPa to about 30 kPa.

Membrane distillation within the LDR unit 200 occurs primarily by latent heat transfer. To help maximize latent heat transfer through minimization of sensible heat transfer, the condensation panel 226 can include one or more slats 248 that function to help minimize sensible heat transfer between the hot panel 224 and the cold panel 222. In an example, the slats 248 are reflective spacers sized and shaped to help minimize radiant heat transfer between the hot panel 224 and the cold panel 222. The reflective spacers can be reflectively coated horizontal slats located within the condensation chambers 240. The slats 248 can be arranged such that the view factor between the hot panel 224 and the cold panel 222 is negligible. In an example, the slats 248 can be arranged such that the view factor between the hot panel 224 and the cold panel 222 is minimized. In examples, the slats 248 are sized and shaped such as to minimize sensible, e.g., radiant, heat transfer without significantly impeding moisture transfer between the hot panel 224 and the cold panel 222.

The above description is intended to be illustrative, and not restrictive. For example, the above-described examples (or one or more aspects thereof) may be used in combination with each other. Other embodiments can be used, such as by one of ordinary skill in the art upon reviewing the above description.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

Various aspects of the disclosure have been described. These and other aspects are within the scope of the following claims.

1. A liquid desiccant regenerator comprising:
a first liquid channel through which a first liquid flows at a first temperature;
a second liquid channel through which a second liquid flows from the first liquid channel and at a second temperature higher than the first temperature;
a condensation cell disposed between the first liquid channel and the second liquid channel; and
a permeable membrane disposed between the second liquid channel and the condensation cell, wherein:
the permeable membrane is configured to permeate gas and vapor and to prevent permeation of liquids and solids;
the second liquid channel comprises a plurality of evaporation chambers fluidly connected to one another in series and defining a second channel flow path along which the second liquid flows through the second liquid channel;
the condensation cell comprises a plurality of condensation chambers each corresponding with one of the plurality of evaporation chambers; and
adjacent pairs of condensation and evaporation chambers each define a distillation stage in which vapor separated from the second liquid can pass from the evaporation chamber through the membrane and into the condensation chamber.

2. The regenerator of claim 1, further comprising an impermeable membrane between the first liquid channel and the condensation cell.

3. The regenerator of claim 1, wherein each of the adjacent pairs of condensation and evaporation chambers, defining a distillation stage, are sized and shaped to have progressively larger evaporation and condensation chamber volumes from an inlet of the second channel to an outlet of the second channel.

4. The regenerator of claim 1, wherein each of the adjacent pairs of condensation and evaporation chambers, defining a distillation stage, are configured to have progressively lower vapor pressures in each of the condensation chambers from an inlet of the second channel to an outlet of the second channel.

5. The regenerator of claim 1, wherein the first liquid is a different liquid than the second liquid.

6. The regenerator of claim 1, wherein the first liquid flowing through the first liquid channel is a dilute solution and the second liquid exiting the second liquid channel is a concentrate solution.

7. The regenerator of claim 6, wherein the dilute solution is a diluted desiccant solution from an air conditioning system, and wherein the concentrate solution is a concentrated desiccant solution to be reused or recirculated back in the air conditioning system.

8. The regenerator of claim 1 further comprising a heat source configured to heat the first liquid and to pass the heated first liquid to the second channel as the second liquid.

9. The regenerator of claim 8, wherein the heat source is recycled heat from an air conditioning system.

10. The regenerator of claim 1, wherein the second liquid channel flow path is a serpentine flow path.

11. The regenerator of claim 10, further comprising a first liquid channel flow path along which the first liquid flows through the second liquid channel, wherein the first liquid channel flow path is a serpentine flow path.

12. The regenerator of claim 1, wherein each of the plurality of condensation chambers are in fluid connection with a vacuum, the vacuum being configured to provide continuous or intermittent suction to reduce air pressure in the plurality of condensation chambers.

13. The regenerator of claim 1, wherein the plurality of condensation chambers each comprise a reflective spacer configured to reduce sensible heat transfer between the first liquid channel and the second liquid channel.

14. A method for using a liquid desiccant regenerator, the method comprising:
passing a first liquid through a first liquid channel at a first temperature;
passing a second liquid through a second liquid channel at a second temperature higher than the first temperature, wherein the second liquid channel includes a plurality of evaporation chambers fluidly connected to one another in series and defining a second channel flow path along which the second liquid flows through the second liquid channel, a condensation cell is disposed between the first liquid channel and the second liquid channel, a permeable membrane is disposed between the second liquid channel and the condensation cell and is configured to permeate gas and vapor and to prevent permeation of liquids and solids, and the condensation cell comprises a plurality of condensation chambers each corresponding with one of the plurality of evaporation chambers; and
permeating vapor separated from the second liquid from each of the plurality of evaporation chambers through the membrane and into each of the corresponding condensation chambers.

15. The method of claim 14, further comprising passing the second liquid sequentially through progressively larger evaporation and condensation chamber volumes from an inlet of the second liquid channel to an outlet of the second liquid channel.

16. The method of claim 14, further comprising passing the second liquid sequentially through distillation stages including progressively lower vapor pressures in each of the plurality of condensation chambers from an inlet of the second channel to an outlet of the second channel.

17. The method of claim 14, wherein the first liquid is a different liquid than the second liquid.

18. The method of claim 14, comprising recycling heat from an air conditioning system to provide heat to the second liquid before passage through the second liquid channel.

19. The method of claim 14, comprising providing continuous or intermittent suction to reduce air pressure in the plurality of condensation chambers via a vacuum fluidly connected to the plurality of condensation chambers.

20. A multistage membrane distillation unit comprising:
a lower-temperature liquid channel configured to pass a liquid along a first flow path from an inlet to and outlet of the lower-temperature liquid channel;
a heat exchanger fluidly connected to the outlet of the lower-temperature liquid channel and configured to heat the liquid;
a higher-temperature liquid channel configured to receive the heated liquid from the heat exchanger at an inlet of the higher-temperature liquid channel and pass the heated liquid along a second flow path defined by a plurality of evaporation chambers connected in series, the second flow path being in an opposite direction to the first flow path;
a condensation cell disposed between the lower-temperature liquid channel and the higher-temperature liquid channel; and
a distillation membrane disposed between the higher-temperature liquid channel and the condensation cell, the distillation membrane including a distilland side and a distillate side;
wherein the condensation cell comprises a plurality condensation chambers, and each of the plurality of condensation chambers is adjacent one of the plurality of evaporation chambers;
wherein adjacent pairs of condensation and evaporation chambers each define a distillation stage in which vapor separated from the higher-temperature liquid channel can pass from the evaporation chamber through the membrane and into the condensation chamber; and
wherein each of the plurality of condensation chambers is configured to transfer latent energy to the lower-temperature liquid channel to condense the vapor into liquid water.

21. The distillation unit of claim 20, further comprising a liquid outlet of the higher-temperature liquid channel, the liquid outlet of the higher-temperature liquid channel configured to supply liquid following passage through a plurality of distillation stages, wherein the liquid at the inlet of the lower-temperature liquid channel is a more dilute solution and the liquid at the outlet of the higher-temperature liquid channel is a more concentrate solution.

22. The distillation unit of claim 20, wherein a contour defined by the first flow path substantially mirrors a contour defined by the second flow path.
